(19) United States
(12) Patent Application Publication
(10) Pub. No.: US 2009/0024503 A1
(43) Pub. Date: Jan. 22, 2009

(54) EFFICIENT DEBT-CLEARING SYSTEM AND METHOD

(76) Inventor: Yung-Sung Chien, Taipei (TW)

Correspondence Address: SINORICA, LLC, 528 FALLSGROVE DRIVE, ROCKVILLE, MD, 20850, US

(21) Appl. No.: 12/119,568

(22) Filed: May 13, 2008

(30) Foreign Application Priority Data
Jul. 19, 2007 (TW) 96126358

(51) Int. Cl. G06Q 40/00

(52) U.S. Cl. 705/35

(57) ABSTRACT

An efficient debt-clearing system and method which is applied to electronic finance is disclosed. Internet technology is utilized to establish a direct-finance fund trading platform, whereby debtors can more efficiently raise funds with a lower cost to clear their debts, particularly the debts of credit cards and fiduciary loans. The efficient debt-clearing system functions as the core in the operation of the entire platform. Firstly, a debtor member submits an application to the platform. The platform analyzes the debt and credit of the debtor member and instructs the debtor to enhance his credit. Next, the platform directs the debtor member to the fund trading module to raise a fund. The fund acquired in fund trading is preferentially used to first clear the existing debt of the debtor member, and the debtor re-pays by installments the fund to the platform.

### BACKGROUND OF THE INVENTION

1. Field of the Invention

The present invention relates to financial services. More particularly, the present invention provides an efficient debt-clearing solution for debtors to access the efficiency of direct finance.

2. Description of the Related Art

Legislation has been enacted with regulations for consumer debt-clearing which raises debt-clearing volition of debtors and decreases bad debts for banks. This legislation restricts some debtors' personal freedom but exempts debtors from part of their debts. However, the legislative method to solve commercial problems can leave debtors with a lifelong record of poor credit rating. For banks, the political interference not only damages their claims but also lowers the velocity of fund circulation. As a result, a vicious circle is created with loaners afraid of loaning and borrowers unable to borrow.

The founder of Grameen Bank, Dr. Muhammad Yunus, the winner of 2006 Nobel Prize and a successful executive among microfinance banks, developed an idea that poverty cannot be solved by subvention but should be addressed by resorting to commercial methods, when he refused help from the World Bank with his low interest rate loan undertaking.

Conventional commercial banks work in a mechanism of indirect-finance fund circulation. However, bank operations make it hard to achieve the optimal efficiency for funds. Further, banks acting as a go-between earn the interest rate difference which raises the trading cost for loaners and borrowers.

US patent publication number US 2006/0080236 A1 discloses a “Method and System for Debt Recovery” to provide a second opportunity for debt recovery for debtors who are heavily-burdened but still willing to clear their debts. In the method, banks provide customers with communication devices, such as pre-paid cards or mobile phone SIM cards, in order to communicate with the banks for a renewed debt clearing schedule to relieve debt pressure when customers consider that they are having difficulty in paying. However, this invention can only provide a communication means to increase the desire of clearing the debt, but can neither improve debt-clearing ability nor provide a detailed debt-clearing plan.

US patent publication number US 2006/0064401 A1 discloses “Systems and Methods for Detecting Fraudulent Information”, which uses variables to classify customer documents into groups, and uses related parameters to evaluate whether there is any fraud in each group of documents. However, it is doubtful that the data from the bank claimed in the said patent can be applied to all groups of customers. Further, raising the standards for credit investigation means to decrease the loan business. Therefore, the technical features of the invention cannot solve the problems for debtors and banks.

US patent publication number US 2003/0074290 A1 discloses “Methods, Systems and Articles of Manufacture for Managing Delinquent Financial Accounts”, and US patent publication number US 2004/0073504 A1 discloses “Systems and Methods for Increasing Recovery Rates on Delinquent Financial Accounts.” Both inventions intend to raise the debt-clearing desire of debtors by providing a new debt recovery mode (such as modifying payment parameters or postponing closing accounts). However, the two inventions cannot solve debt problems with a direct-finance means but only change the policy to encourage debtors.

The first prior art intends to prevent problems of bad debts beforehand. The latter three prior arts use retrospective means to reduce bad debt rates. However, they all use indirect-finance means and are not the most efficient approach.

Therefore, the present invention provides an improved method and system compared with the foregoing four patents for solving the above-mentioned problems on efficiently clearing debt.

### SUMMARY OF THE INVENTION

To achieve these and other advantages and in order to overcome the disadvantages of the conventional method in accordance with the purpose of the invention as embodied and broadly described herein, the present invention provides a method and system for efficiently clearing debt utilizing direct finance.

The present invention develops the efficiency of direct finance in order to provide a debt clearing solution for debtors. The present invention establishes a direct-finance fund trading platform with Internet technology and uses a fund flow matching and trading mechanism to allow debtors to raise funds to clear their debts, particularly credit card and fiduciary loan debts, which have very high interest rates.

The present invention solves commercial problems with a commercial method which regenerates the quality of debtors' living and life without penalties of credit rating degradation and restriction on freedom.

Accordingly, the present invention makes full use of the high efficiency of direct finance to provide an efficient debt clearing solution.

An object of the present invention is to regenerate the quality of debtors' living and life. Interest rates, particularly the interest rates of credit cards and fiduciary loans, are so high that it is hard for debtors to clear the debt despite their willingness to do so.

According to the Consumer Debts Resolution Act, a debtor cannot resolve his debt unless he files for bankruptcy. However, bankruptcy will greatly impact the credit and lifestyle of debtors. The present invention provides a method for clearing old debts by providing direct-finance loans to increase the repayment ability of debtors and minimize the impact from debts.

Another object of the present invention is to reduce the number of non-performing loans for banks. Via the present invention, debtors can pay for debts with lower interest rates. Therefore, the repayment ability of debtors is greatly improved and the willingness to clear debts is also obviously enhanced. Thus, the ratio of non-performing loans is greatly reduced.

Another object of the present invention is to promote the efficiency of social operations. The government intends to solve the debtors' problems with the Consumer Debts Resolution Act. However, the employment of public policy to solve commercial problems cannot achieve the best effect and can only achieve nominal effects. The present invention uses Internet technology to develop an electronic finance module, which fully exploits the efficiency drop between direct finance and indirect finance to help debtors, promote fund operation efficiency and facilitate social stabilization.

Another object of the present invention is to create rules for direct finance and loaner-borrower integration. The present invention uses a fund flow mechanism to match loaners and debtors, eliminate the inefficiency of go-between operations by traditional banks (indirect finance) and realize direct finance. The present invention further provides a new way to integrate loaners and borrowers and promote flexibility for users.

Another object of the present invention is to speed up fund acquisition and enhance the efficiency of the procedure by using the Internet. The present invention provides an electronic commercial system and constructs an electronic commercial website to facilitate participants' usage, whereby they needn't go to a bank and contact the teller personally, and save a lot of time.

To achieve the above-mentioned objectives, the present invention provides an efficient debt-clearing system, which comprises an administrating server linking to users via a communication system or a network, providing a user's interface for the users. The administrating server can exchange information with users in realtime in a safe system environment. When applicants apply for membership and input their personal information, the administrating server analyzes the input information to obtain the attributes of members and classifies the members according to their attributes. The administrating server also takes charge of monitoring and controlling the process of credit enhancement and the process of signing bidding authorization contracts, directing members to fund trading, and executing settlement and delivery procedures. The system of the present invention comprises a database storing the information for the above-mentioned operations, the results and the updated data thereof. The system of the present invention further comprises the following modules:

A membership application module: The administrating server uses the membership application module to process the personal data input by a user and verify whether the user qualifies for general membership or for debtor membership. The information is stored in the database. Later when the user logs into the system, the membership application module will retrieve the information for identification.

A member classification module: The administrating server uses the member classification module to analyze the fundamental data and financial states of members, classify the members into debtor members and general members, and store the information in the database.

A credit enhancement module: The debtor member may choose to provide collateral or a guarantor and the credit enhancement module will assess or examine the credit enhancement tools and store the information in the database.

A member directing into fund trading module: The administrating server uses the member directing module to straightly direct general members to fund trading and make bidding authorization contracts with debtor members. After the bidding authorization contract is signed, the member directing module directs a debtor member to a suitable fund trading pool based on his/her available fund and supportable contribution payment, analyzes the bidding conditions of all members in fund trading, evaluates the performance of bid-winners, and stores the information in the database.

A settlement and delivery module: The administrating server uses the settlement and delivery module to process settlement and delivery for bid-winners, non bid-winners and debtor members and then stores the information in the database.

In the efficient debt-clearing system of the present invention, an administrating server links to members via communication systems or networks and provides specific webpage links for members to access through their own devices. The method of the present invention comprises the following steps: the system accepts a user's input of personal information in the system webpage, verifies the user's identity and provides an account number and a password for the user if he/she qualifies for membership; the system analyzes the user's attributes, credit and financial data and determines whether the user is a general member or a debtor member; the system instructs a debt-clearing member to provide a guarantor or collateral and requires him to sign a bidding authorization contract; after accepting the information that the guarantor or collateral has been received and the bidding authorization contract has been signed, the system directs the debtor member to fund trading and executes a procedure that the assignor and general members undertake fund trading simultaneously; after completing fund trading, the system undertakes settlement and delivery for bid-winners and non bid-winners of general members and appropriates the fund from fund trading to redeem the existing debt for the debtor member having completed a bid; then the system monitors whether the debtor members of this type regularly pays the installment payments for the funds they acquired in fund trading.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating an efficient debt-clearing system according to an embodiment of the present invention;

FIG. 2 is a flowchart illustrating an debt-clearing method according to an embodiment of the present invention; and

FIG. 3 is a flowchart illustrating the process for a debtor member to attend fund trading according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

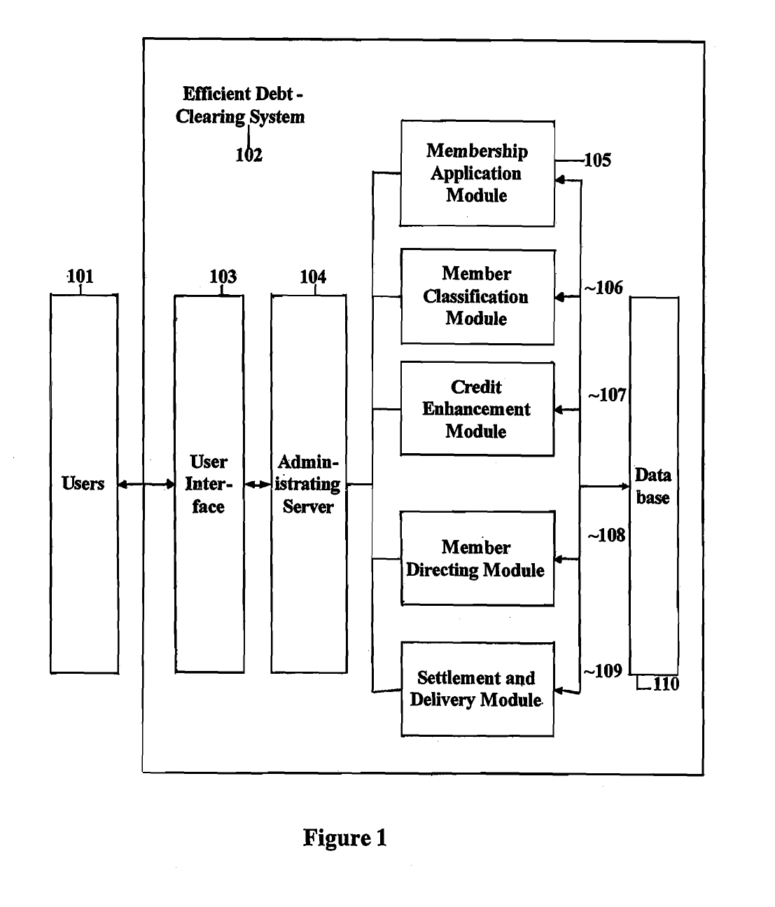

Refer to FIG. 1, which is a diagram illustrating an efficient debt-clearing system according to an embodiment of the present invention. The efficient debt-clearing system 102 comprises an administrating server 104. Users 101 link to the administrating server 104 via a user interface 103 via computers, mobile phones, PDA, etc. The administrating server 104 exchanges information safely and in real time with members via communication networks, wired communication devices, or wireless communication devices. The administrating server 104 also links to a database 110 and several modules and stores data, information and results in respective databases. In the present invention, the efficient debt-clearing system 102 further comprises the following modules:

A membership application module 105: The membership application module 105 examines the basic data of an applicant and verifies whether he/she qualifies for membership. Then, the administrating server 104 calculates, processes, analyzes and cross-checks the data and executes the results and then stores the information in the database 110.

General member attribute classification module (106): Administrating server employs this module to analyze the members' basic data and financial states, classifying the members into general members and debtor members, and store the information in the database 110.

A credit enhancement module 107: The debtor member may choose to provide collateral or a guarantor; the credit enhancement module 107 assesses and examines the credit enhancement tools. Then, the administrating server 104 calculates, processes, analyzes and cross-checks the data and executes the results and then stores the information in the database 110.

A member directing module: The administrating server 104 uses this module to directly direct general members to fund trading and sign bidding authorization contracts with debtor members. By the bidding authorization contract and based on the available fund and affordable contribution payment for each term, the member directing module analyzes the bidding conditions in fund trading of all members, and evaluates the function of bid-winners and then stores the information in the database 110.

Wherein, the above-mentioned fund trading refers to a capital bidding mechanism provided by the module. First, the module sets a contribution amount for each term, a payment interval, and payment terms. The contribution amount of each term multiplied by the payment terms is a target funding, on which the member bids in the capital bidding mechanism. The member may bid on the installment interest he/she is willing to pay for each term, wherein the installment interest is a bid price placed by the member. If the member wins, he/she may obtain a total payment receivable to clear his/her debt. The total payment receivable is calculated by the following two equations according to order of paid interest:
If the interest is paid first:

An=(U−ln)×((N−n)+(U×(n−1)) Equation (1)
If the interest is paid later:

$$A n = ( U \times ( N - n ) ) + ( U \times ( n - 1 ) ) + {\sum }_{i = 1}^{n - 1} li . \qquad Equation ( 2 )$$

‘An’ represents a total amount of an nth term obtained by the bid winner,
‘U’ represents the contribution amount,
‘N’ represents a total number of terms,
‘n’ represents a placed term,
   ‘ln’ represents the bidding price in the nth term. Namely, ‘ln’ is a valid bid price and also represents interest of each term offered by the member (herein entrusted by the platform to bid).

A settlement and delivery module 109: The settlement and delivery module 109 processes the settlement and delivery of the fund-trading (bidding) result, delivers funds to the bid-winners among general members, collects deposits from the non bid-winners of general members, appropriates funds to clear existing debts for debtor members and then monitors whether the debtor members regularly pay the installment payment for the funds they acquired in fund trading. Then, the administrating server 104 calculates, processes, analyzes and cross-checks the data and executes the results and then stores the information in the database 110.

As mentioned above, the database 110 stores the results of calculating, processing, analyzing, cross-checking, and executing the corresponding functions of each module by the administrating server 104. The administrating server 104 and the above-mentioned modules also retrieve data from the database 110 to calculate, process, analyze, cross-check and execute.

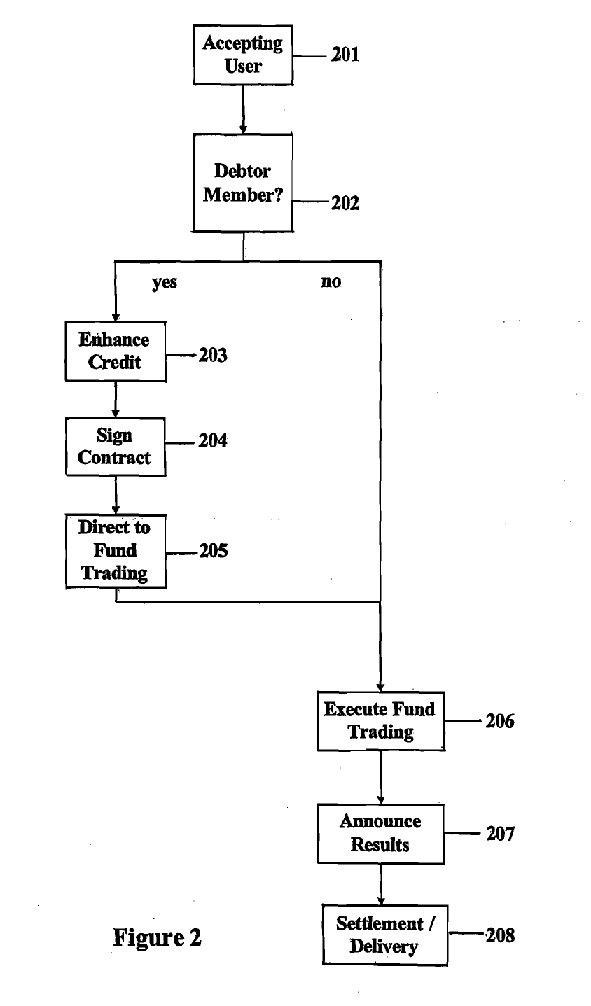

Refer to FIG. 2, which is a flowchart illustrating a debt-clearing method according to an embodiment of the present invention. The efficient debt-clearing method of the present invention comprises the following steps: the efficient debt-clearing system accepts a user as a member of the system (201), and the user can be a general member or a member with debt-clearing needs; the system analyzes the user's attributes, credit and financial data and determines whether the member is a general member or a debtor member (202); if the user is a general member, the system leads the general member directly to undertake fund trading (206); if the user is a debtor member, the system demands he/she to provide a guarantor or collateral to enhance his/her credit (203); after receiving the information that the credit has been enhanced, the system instructs the debtor member to sign a bidding authorization contract (204); after receiving the information that the bidding authorization contract has been signed, the system directs the debtor member to fund trading (205) and executes a procedure that general members and debtor members undertake fund trading simultaneously (206); after fund trading is completed, the system announces the result (207) and processes settlement and delivery (208).

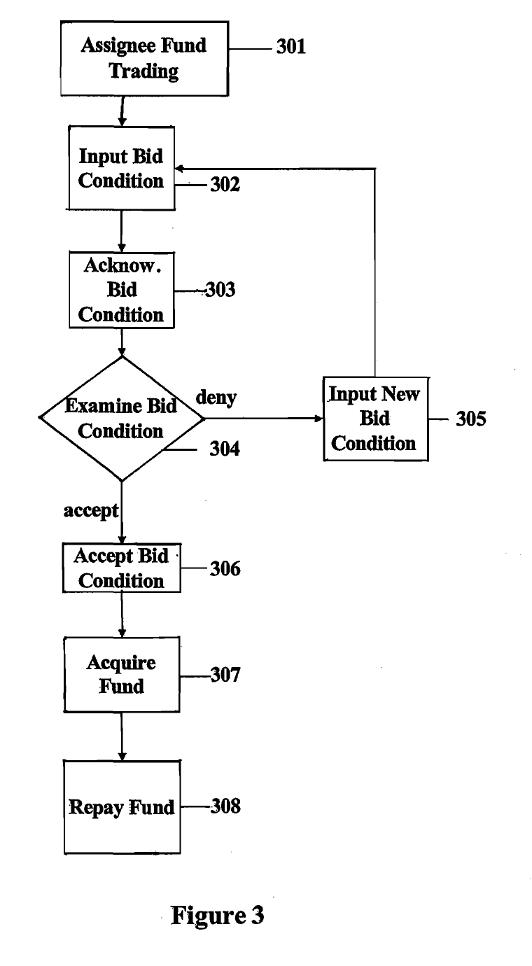

Refer to FIG. 3, which is a flowchart illustrating the process for a debtor member to attend fund trading according to an embodiment of the present invention. Firstly, the system receives the information that an assignee of a debtor member intends to participate in fund trading (301). Next, the system receives the bidding conditions for fund trading input by the assignee (302). Next, the system acknowledges the bidding conditions for fund trading (303). Next, the system examines the bidding conditions for fund trading (304). If the bidding conditions do not pass the examination, the system provides an opportunity to input new bidding conditions (305), and the assignee inputs bidding conditions for fund trading again (302). If the system accepts the bidding conditions, the bid is done (306). Next, the system clears the existing debt for the debtor member with the funds acquired from fund trading (307). Then, the system monitors whether the debtor member regularly pays the installment payment for the funds he has acquired in fund trading.

Examples below are further used to demonstrate the embodiments of the present invention.

### EXAMPLE 1

Mr. A is a newly hired businessman who spends normally and has no expensive indulgence. Mr. A has a monthly income of NT$36,000 and has a balance of about NT$10,000 dollars after deducting his rent, utility bills, living expenses, etc. However, Mr. A had been careless in his spending while he was a student. He used his cash card and credit card to buy a motorcycle, mobile phones, video games and name brand items, and spent up to over NT$40,000. Although Mr. A worked hard part-time to pay his debts while he was a student, he still had a debt of NT$300,000 dollars when he graduated. Although Mr. A had a stable salary income later, it was still hard for him to pay off the debt in a single payment because he had no savings. Under the pressure of re-payment from the shark-like credit card bank and a high compound credit card interest rate of 19.71%, Mr. A could not but become a slave to his debt, despite his stable income and willingness to pay the debt.

Later, Mr. A heard about a new financial product—an “Efficient Debt-Clearing System and Method” invented by Shacom.com Inc. and promoted by a certain bank, which helps a stable-income debtor to amortize his debt at a rational interest rate so that the person can be freed from a high compound interest rate or compulsory delivery of the principal and interest in a single payment. The Efficient Debt-Clearing System and Method directly pays off all the principal of the existing debt. Further, the amortization is repaid periodically by a fixed amount which is easy for a debtor. The method further exempts the debtor from the compound interest of the original debt and decreases the number of terms for clearing the debt. For Mr. A, it was indeed good news. Thus, Mr. A immediately attended the system of the present invention to get rid of the debt pressure as soon as possible.

Firstly, Mr. A applied online for membership to the platform of the system of the present invention, and the platform examined and approved his application. Next, Mr. A input related data, such as his background, the sum of his debts, his payment ability per month, and affordable interest rate range. Next, the platform analyzed the attributes of Mr. A and determined that the platform would loan Mr. A about NT$300,000 to clear his existing debt. As Mr. A had just started working and had no savings, the platform would take too high a risk to make an unsecured loan to Mr. A. Therefore, the platform required Mr. A to enhance his credit to insure that the loan can be repaid. The platform provided three ways to enhance credit: a guarantor, real estate mortgage, and collateral. After consideration, Mr. A chose the guarantor policy to enhance his credit and asked his aunt to be a guarantor. Then, the platform negotiated with Mr. A about the sum for clearing his debt and the loan conditions. Based on the fund trading standard and the attributes of Mr. A, the platform worked out a loan and a loan interest rate most suitable to Mr. A. For example, Mr. A had a total debt of NT$300,000, and his payment ability was NT$10,000 dollars per month. Thus, after calculation, the platform determined that it was most suitable for Mr. A to attend a fund trading pool of 36 terms (the interval for one term is one month, and the period is three years) and a contribution amount of NT$10,000 per month. In other words, the loan amount for Mr. A was NT$360,000. After calculation, the platform could make the loan with an annual interest rate of 10%, and the platform would use the interest rate as the bidding condition to attend fund trading for Mr. A. After Mr. A agreed to the conditions, the platform made a bidding authorization contract with Mr. A, which authorized the platform to execute fund trading for Mr. A.

After all the preliminary processes were completed, the platform directed Mr. A to the above-mentioned fund trading group and bid with a price of NT$1,391—equivalent to an annual interest rate of 10%. According to the mechanism of fund trading, the receivable Mr. A could acquire from fund trading was worked out from the following equations:

The receivable in the nth term:

$$\begin{matrix}A n = ( U - In ) \times ( ( N - n ) ) + ( U \times ( n - 1 ) ) or & Equation 1 \\ A n = ( U \times ( N - n ) ) + ( U \times ( n - 1 ) ) + {\sum }_{i = 1}^{n - 1} Ii & Equation 2\end{matrix}$$

wherein
An denotes the total receivable of the nth term bid winner,
U denotes the contribution amount,
N denotes the total terms,
n denotes the number of the current term,
   In denotes the bidding price in the nth term, which means the interest a member (Herein the platform is authorized to bid) having bid effectively and completed fund trading is willing to pay in each term.

Suppose the platform bid with a price of NT$1,391 in the first term; according to Equation 1, the fund the platform (i.e. Mr. A) could acquire from fund trading is:

(NT$10,000−NT$139.10)×(36−1)+NT$1,000×(1−1)=NT$301,315.

After the results of fund trading were announced, the platform acquired NT$30 1,315 with a bid of NT$1,391. Next, the platform directly remitted NT$300,000 to the credit card bank to clear the existing debt of Mr. A, and the debtor-creditor relationship was transferred to Mr. A and the platform. The platform also remitted the remaining NT$1,315 to Mr. A. Then, Mr. A had to pay the contribution amount of NT$10,000 periodically (each month) to the fund trading pool of the platform until the thirty-sixth term. Thus, Mr. A easily cleared all his debt and ridded the credit card debt pressure.

If Mr. A repaid the original credit card bank in the same mode as mentioned above, i.e. NT$10,000 each month, he had 42 terms of amortizations to pay under a credit card interest rate of 19.71%. In contrast, with the present invention, the number of terms of paying the amortizations can be reduced to 36. Thus, the present invention can save Mr. A six terms of amortizations. Therefore, Mr. A was sensible to opt for the above method to shorten the debt-clearing period and reduce the burden of interest.

### EXAMPLE II

Three years later, Mr. B, a classmate of Mr. A in high school, had completed military service. Mr. B has a master's degree and moved to the city from his hometown to look for a job. After many job interviews at different companies, Mr. B finally found a job in a big trading company in a month or two. Mr. B had a salary of NT$45,000. Although the inflation was persistently rising, it was still a good beginning salary for an inexperienced person like him in the profession. Mr. B rented a house close to his company and used his credit card to borrow NT$250,000 to buy some simple furnishings, furniture, and necessary household appliances.

Although Mr. B had started working and had a stable income, he didn't have sufficient savings to clear all the debt in a single payment. After collecting and gathering as much funds as possible to pay back the credit card bank, he still owed the bank NT$200,000. Thus, the credit card bank bloodlessly forced Mr. B to carry an unreasonable amortization for the principal and interest with an overly high compound interest rate of 19.71%. Although Mr. B had a balance of about NT$20,000 after deducting his rent, utility bills, living expense, etc, it was still hard for him to afford the payments and he could not help feeling the pressure from the debt. With all willingness to pay back his debt, he could not but become the victim to his credit card debt.

Later, Mr. B learned from Mr. A about a new financial product—an “Efficient Debt-Clearing System and Method” invented by Shacom.com Inc., which had operated for several years and had a reputation of having helped many people, wherein the system and method helped a stable-income debtor to amortize his debt at a reasonable interest rate so that the person can be free from high interest rates or compulsory clearing of the principal and interest in a single payment. The Efficient Debt-Clearing System and Method directly pays off all the principal of the existing debt. Further, the amortization is paid periodically by a fixed amount, which is easy for a debtor and also can exempt the debtor from the compound interest of the existing debt and decrease the number of terms for clearing the debt. Naturally, it is good news for Mr. B. Thus, Mr. B decided to accept the service of the present invention to get rid of the debt pressure as soon as possible.

Firstly, Mr. B applied online for membership to the platform, and the platform examined and approved his application. Next, Mr. B input related data, such as his background, the sum of his debts, his payment ability per month, and affordable interest rate range. Next, the platform analyzed the attributes of Mr. B and determined that the platform would loan Mr. B about NT$200,000 to clear the existing debt. As Mr. B had just begun to work and had no savings, the platform would take too high a risk to make an unsecured loan to Mr. B. Therefore, the platform demanded Mr. B enhance his credit to insure that the loan can be repaid. The platform provides three ways to enhance credit: a guarantor, real estate mortgage, and collateral.

After consideration, Mr. B decided to use a famous wooden sculpture “Four Flying Fairies” having a market price of NT$200,000 as collateral. Then, the platform negotiated with Mr. B about the sum for clearing his debt and the loan conditions. Based on the standard of fund trading and the attributes of Mr. B, the platform worked out a loan and a loan interest rate suitable to Mr. B. For example, Mr. B had a total debt of NT$200,000, and his payment ability was NT $20,000 per month. Thus, after calculation, the platform determined that it was most suitable for Mr. B to attend a fund trading pool with 12 terms (the interval for one term is one month, and the period is one year) and a contribution amount of NT$20,000 per month. In other words, the loan amount for Mr. B was NT$240,000. After calculation, the platform could make the loan with an annual interest rate of 12%, and the platform would use the interest rate as the bidding condition to attend fund trading for Mr. B. After Mr. B agreed to the conditions, the platform made a bidding authorization contract with Mr. B, which authorized the platform to execute fund trading for Mr. B.

After all the preliminary processes were completed, the platform directed Mr. B to the above-mentioned fund trading pool and bid with a price of NT$1,15 0—equivalent to an annual interest rate of 12%. According to the mechanism of fund trading, the receivable Mr. B could acquire from fund trading was worked out from the following equations:

The receivable in the nth term:

$$\begin{matrix}A n = ( U - In ) \times ( ( N - n ) ) + ( U \times ( n - 1 ) ) or & Equation 1 \\ A n = ( U \times ( N - n ) ) + ( U \times ( n - 1 ) ) + {\sum }_{i = 1}^{n - 1} Ii & Equation 2\end{matrix}$$

wherein
An denotes the total receivable of the nth term bid winner,
U denotes the contribution amount,
N denotes the total terms,
n denotes the number of the current term,
   In denotes the bid price in the nth term, which means the interest a member (Herein the platform is authorized to bid.) having bid effectively and completed fund trading is willing to pay in each term.

Suppose the platform bid with a price of NT$1,150 in the first term; according to Equation 2, the fund the platform (i.e. Mr. B) could acquire from fund trading is:

(NT$20,000−NT$1,150)×(12−1)=NT$207,350.

After the fund trading results were announced, the platform acquired NT$207,350 with a bidding condition of NT$1,150. Next, the platform directly delivered NT$200,000 to the credit card bank to clear the existing debt of Mr. B, and the debtor-creditor relationship was transferred to Mr. B and the platform. The platform also delivered the remaining NT$7,350 dollars to Mr. B. Then, Mr. B had to pay the contribution amount NT$20,000 periodically (each month) to the fund trading group of the platform until the twelfth term. Thus, like Mr. A, Mr. B also easily cleared all his debts and ridded his debt pressure.

It will be apparent to those skilled in the art that various modifications and variations can be made to the present invention without departing from the scope or spirit of the invention. In view of the foregoing, it is intended that the present invention covers modifications and variations of this invention provided they fall within the scope of the invention and its equivalent.

What is claimed is:

1. An efficient debt-clearing system comprising:
a user interface for allowing a user to log into the debt-clearing system via network communication;
a database for storing data; and
an administrating server for linking the user interface and the database, the system allowing the user and more users to raise debt-clearing funds with low costs.

2. The administrating server, according to claim 1, executes debt-clearing procedures by means of computing by each functional module; the administrating server further comprising:
a membership application module for storing application data input by the user and for examining whether the user qualifies for membership;
a member attribute classification module for retrieving member data to classify a member according to attributes of the member;
a credit enhancement module for calculating a credit enhancement amount the member needs and a credit amount that requires the member provide a collateral or a guarantor;
a member directing module for directing the member to fund trading; and
a settlement and delivery module for executing settlement and delivery processes.

3. The membership application module according to claim 2, the user using a computer, a PDA (Personal Digital Assistant) via a wired or wireless network connection or a mobile phone to connect to the administrating server.

4. The member attribute classification module according to claim 2, the member classification module classifying the member according to data in the database, the data comprising whether the member needs to clear debt, a credit state of the member, income of the member, and ability of the member to provide a collateral or a guarantor.

5. The credit enhancement module according to claim 2, the credit enhancement module providing a debtor member with a guaranteed credit line calculated according to data in the database comprising collateral and guarantor data.

6. The member directing module for directing the member to fund trading according to claim 2, the member directing module executing a fund bidding process in a fund trading module for the member or an assignor and determining acquirement of funds by comparing a bid criterion and a fund reserve criterion.

7. The settlement and delivery module according to claim 2, the settlement and delivery module receiving and delivering funds on a platform, executing receiving and paying for fund trading pools, clearing existing debts with funds acquired in fund trading, and receiving re-payments paid by members.

8. An efficient debt-clearing method for allowing a debtor member to raise debt-clearing funds and speed up debt-clearing and amortize debt with a lower-cost fund comprising:
a logging-in step;
a membership application step;
a member classification step:
a credit enhancement step;
a bidding authorization step;
a member directing step; and
a settlement and delivery step.

9. The member classification step according to claim 8, the member classification step comprising classifying a member according to whether the member needs to clear debt, a sum of the debt of the member, a credit state of the member, income of the member, and ability of the member to provide a collateral or a guarantor.

10. The member directing step according to claim 8, the member directing step comprising:
a bidding condition inputting step;
a bidding condition acknowledging step;
a bidding data examining step;
a bidding step;
a fund trading result announcing step;
an existing debt clearing step; and
a periodically amortizing debt-clearing fund step.

11. The bidding condition acknowledging step according to claim 10, the bidding data examining step comprising examining bidding data and if bidding data passes an examination procedure bidding proceeds and if bidding data does not pass the examination procedure the bidding condition inputting step is executed again.

12. The bidding step according to claim 10, wherein objects of bidding comprise a plurality of fund trading pools with varying periods, different payment time periods, and different contribution amounts.

13. The bidding step according to claim 10, wherein bidding is executed by a member or a financial organization managing a related platform and authorized by the member.

14. The bidding step according to claim 13, wherein if bidding is executed by the financial organization, the financial organization is only an assignee of the debtor member and the debtor member is subject to rights and obligations for fund reception and payment.

15. The member directing step according to claim 8, wherein the member directing step, whether a bidder is able to acquire a fund depends on a result of a competition between a bid price input by the bidder and a fund reserve of a related platform.

16. The fund trading result announcing step according to claim 10, wherein announced information comprises basic data of bidders, fund trading pool types, all input bid prices, and bid-winning prices.

17. The existing debt-clearing step according to claim 10, wherein a fund acquired in fund trading by a debtor member or an assignee of the debtor member is used to clear an existing debt of the debtor member.

18. The existing debt-clearing step according to claim 17, wherein a creditor of the existing debt is a financial organization, enterprise, or an individual managing a related platform or a financial organization, enterprise, or individual cooperating with said related platform.

19. The periodically amortizing debt-clearing fund step according to claim 10, wherein if a debtor member has acquired a fund in fund trading, the debtor member pays a repayment of a bidding amount regularly since the debtor member acquired the fund.

20. The settlement and delivery step according to claim 8, the settlement and delivery step further comprising:
delivering a fund to a member, the member acquiring the fund to clear an existing debt and periodically paying repayment of the fund; and
charging a penalty for a delayed repayment and an additional interest for the delayed repayment.
